(19) United States
(12) Patent Application Publication
(10) Pub. No.: US 2012/0255964 A1
(43) Pub. Date: Oct. 11, 2012

(54) Re-sealing Beverage Containers

(76) Inventor: Andrew N. Searles, Yemassee, SC (US)

(21) Appl. No.: 13/437,108

(22) Filed: Apr. 2, 2012

Related U.S. Application Data
(60) Provisional application No. 61/471,893, filed on Apr. 5, 2011.

(51) Int. Cl. B65D 41/16; B23P 17/04

(52) U.S. Cl. 220/780; 29/428

(57) ABSTRACT

A cap and a method are disclosed for re-sealing a container having a rim extending around a top with a dispensing opening therein. The cap includes a recess with a frusto-conical sealing surface along a sealing construct of a material providing renitent characteristics such that upon engaging the cap with the container, a stick-slip advancement of the cap onto the container creates a discernable audible signal indicative of the completion of an effective seal between the cap and the container.

This application claims the benefit of U.S. Provisional Patent Application Ser. No. 61/471,893, filed Apr. 5, 2011, the disclosure of which is incorporated herein in its entirety by reference thereto.

The present invention relates generally to the use of beverage containers and pertains, more specifically, to re-sealing a carbonated beverage container, such as a beverage can, to preserve carbonation in any contents remaining after some contents are dispensed.

Carbonated beverages commonly are sold in cans which, once opened for dispensing of the beverage in the can, are not easily closed again, should it be desired to store any portion of the beverage remaining in the can subsequent to dispensing. In many instances, a person will drink or otherwise dispense only a portion of the contents of a carbonated beverage can and is faced with re-sealing the can in such a way as to prevent escape of the carbonizing gas (CO₂) and the beverage going “flat”.

The present invention provides a simple and effective method and apparatus for re-sealing a carbonated beverage can to enable preservation of the carbonation of the beverage remaining in the can. As such, the present invention attains several objects and advantages, some of which are summarized as follows: Provides a one-piece cap of simple construction for use in establishing an effective seal for re-sealing an open carbonated beverage container; enables increased simplicity and ease in effectively re-sealing a carbonated beverage can for preserving carbonation of the contents of the can; provides a user with an audibly discernable signal indicative of the completion of an effective seal at the top of an otherwise open carbonated beverage can; provides a simplified construction in an effective cap for re-sealing beverage containers, enabling economical manufacture in large numbers of consistent high quality, exceptional durability and ease of use, capable of exemplary performance over an extended service life.

The above objects and advantages, as well as further objects and advantages, are attained by the present invention which may be described briefly as a cap for re-sealing a container having an axially extending body with a laterally extending top surrounded by a rim having prescribed lateral dimensions, the top including a dispensing opening therein, the cap comprising: a member having an axial length between an upper end and a lower end, and an outer perimeter along lateral widths greater than the lateral dimensions of the rim; a recess extending axially within the member, from the lower end toward the upper end of the member, the recess being spaced laterally from the outer perimeter of the member and axially from the upper end of the member; and an internal engagement surface extending along the recess between the lower end and the upper end of the member, the internal engagement surface having a tapered configuration following a taper angle providing a sealing surface intermediate the upper and lower ends, the sealing surface having interior dimensions complementary to the prescribed lateral dimensions of the rim; the member including a sealing construct of a material having a combination of elasticity and hardness providing renitent characteristics such that upon engagement of the sealing surface with the rim of the container, relative movement between the cap and the container to effect axial movement between the sealing surface and the rim urging the upper end of the member axially toward the rim will effect a stick-slip advancement of the member onto the container and a concomitant audibly discernable signal indicative of the completion of a sealed relationship between the member and the rim and, consequently, an effective seal between the cap and the container.

In addition, the present invention provides a method for re-sealing a container having an axially extending body with a top surrounded by a rim having prescribed lateral dimensions, the top including a dispensing opening therein, the method comprising: providing a cap including a member having an axial length between an upper end and a lower end, and an outer perimeter along lateral widths greater than the lateral dimensions of the rim, a recess extending axially within the member, from the lower end toward the upper end of the member, the recess being spaced laterally from the outer perimeter of the member and axially from the upper end of the member, and an internal engagement surface extending along the recess between the lower end and the upper end of the member, the internal engagement surface having a tapered configuration following a taper angle providing a sealing surface intermediate the upper and lower ends, the sealing surface having interior dimensions complementary to the prescribed lateral dimensions of the rim, the member including a sealing construct of a material having a combination of elasticity and hardness providing renitent characteristics; engaging the sealing surface with the rim of the container; and effecting relative movement between the cap and the container to bring about axial movement between the sealing surface and the rim urging the upper end of the member axially toward the rim in a stick-slip advancement of the member onto the container until an audible signal indicates completion of a sealed relationship between the member and the rim and, consequently, an effective seal between the cap and the container.

The present invention will be understood more fully, while still further objects and advantages will become apparent, in the following detailed description of preferred embodiments of the invention illustrated in the accompanying drawing, in which:

FIG. 1 is an exploded pictorial view showing a beverage container in the form of an open carbonated beverage can, about to be re-sealed with a cap, in accordance with the present invention;

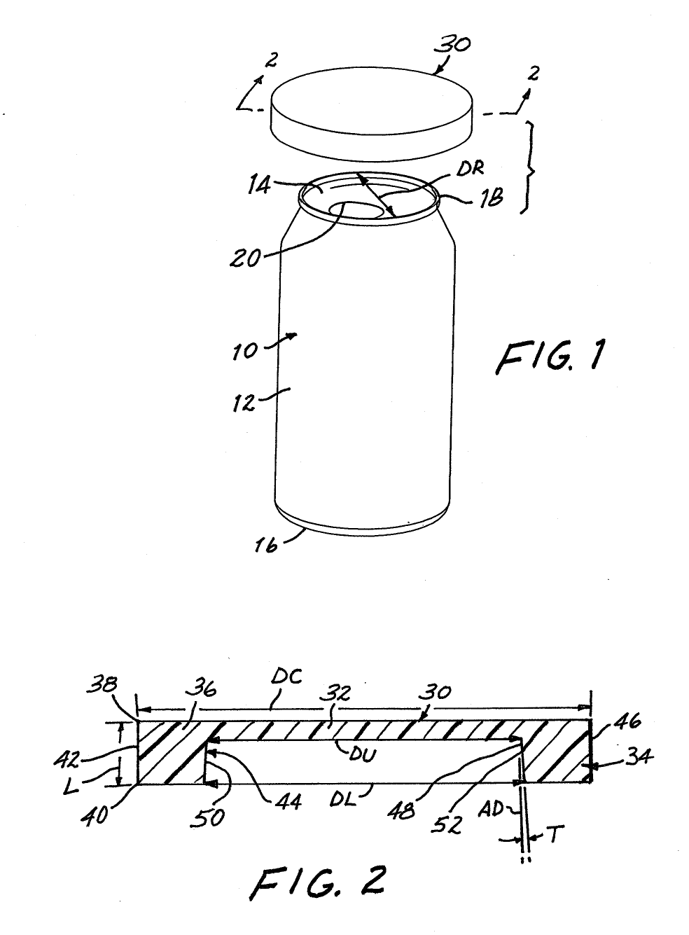

FIG. 2 is an enlarged lateral cross-sectional view of the cap, taken along line 2-2 of FIG. 1;

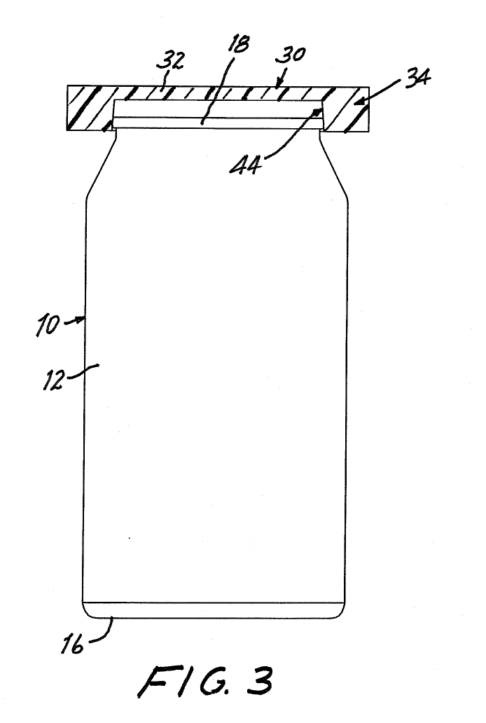

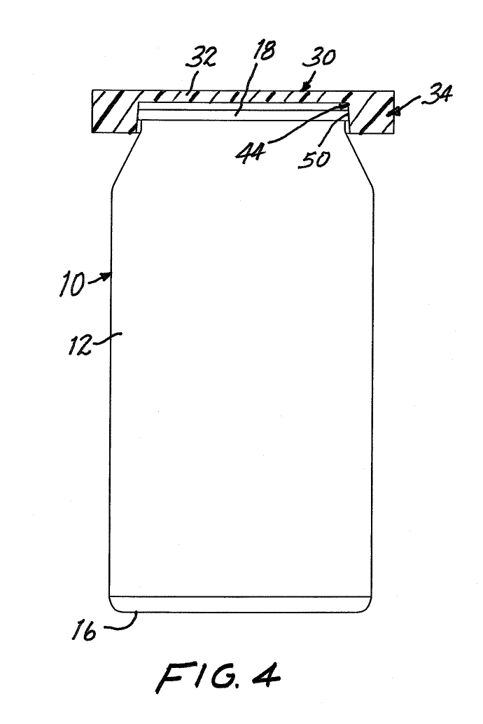

FIG. 3 is an elevational view showing the cap in cross-section and illustrating the beverage can in an initial stage of being re-sealed with the cap;

FIG. 4 is an elevational view similar to FIG. 3 and showing the cap in place, re-sealing the beverage can; and

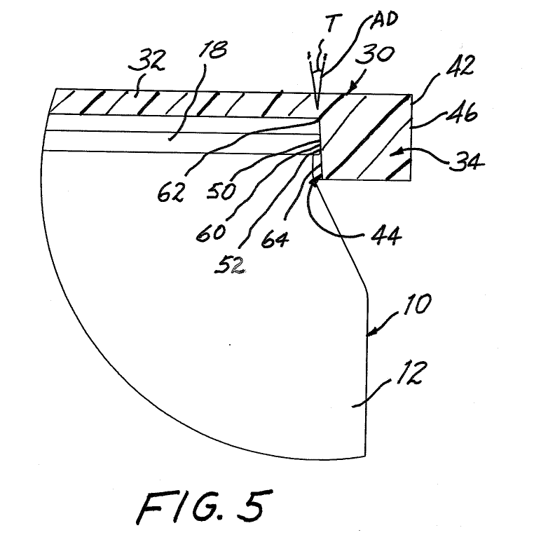

FIG. 5 is a further enlarged fragmentary view of a portion of FIG. 4.

Referring now to the drawing, and especially to FIG. 1 thereof, a common carbonated beverage container is shown in the form of a can 10 having a cylindrical body 12 extending axially between a top 14 and a bottom 16. As is conventional in the construction of such cans, can 10 includes a circular rim 18 extending circumferentially around the top 14 and having prescribed lateral dimensions, shown in the form of given diameters, one of which is shown at DR. A dispensing opening 20 is provided in top 14 in the conventional manner.

When the top 14 of can 10 is exposed, the dispensing opening 20 is available for drinking directly from can 10, or for otherwise dispensing the contents of can 10. In this instance, can 10 contains a cooled carbonated beverage, some of which has been dispensed from can 10, and a cap constructed in accordance with the present invention is illustrated at 30 in FIGS. 1 through 3, seen in FIG. 1 about to be engaged with can 10, and shown in FIG. 3 in a first stage of the process of being engaged with can 10 to re-seal can 10, and preserve carbonation of some volume of beverage remaining in the can 10. To that end, cap 30 includes a closed top 32 surrounded circumferentially by a depending sealing construct 34 in a unitary member 36 having an axial length L extending between an upper end 38, a lower end 40, and an outer perimeter 42 along lateral widths shown in the form of diameter DC which is substantially greater than the lateral dimensions of rim 18. An inner recess 44 extends axially within member 36, from the lower end 40 toward the upper end 38, and the cap 30 includes a handgrip 46 extending along outer perimeter 42, spaced laterally from the recess 44. As best seen in FIGS. 2 through 5, recess 44 includes an internal engagement surface 48 providing a sealing surface 50 which is tapered and follows a substantially continuous frusto-conical configuration 52 extending axially along internal engagement surface 48. Frusto-conical configuration 52 follows a relatively shallow taper angle T relative to the axial direction AD.

Cap 30 is constructed with member 36 being of a synthetic polymeric material having a prescribed balance between elasticity and hardness which provides sealing surface 50 with renitent characteristics, as will be described below, that, in concert with the relatively shallow taper angle T, enable sealing surface 50 of the sealing construct 34 to grip rim 18 of can 10 and establish an effective seal. The material of member 36 preferably is selected from the group consisting of acrylic, polycarbonate, and rigid polyurethane, the selected material having a modulus of elasticity of about 250,000 to 600,000 psi and a hardness between about Shore D70 and Rockwell R150. The magnitude of taper angle T is great enough to accommodate variations encountered from can to can in the diameter DR of rim 18, while being not so great as to require excessive force to seat cap 30 on a particular rim 18 and effect the desired seal. The magnitude of taper angle T is within a range of about 2° to about 6°, with the preferred taper angle T being about 4°. The taper angle T assures the establishment of an effective grip on the rim 18 of can 10 while making certain that can 10 is re-sealed. For use in re-sealing a typical carbonated beverage can 10, wherein the diameter DR of rim 18 is within a range of about 2.110 to 2.135 inches, the diameter DL of recess 44 at lower end 40 of member 36 is nominally 2.125 inches, while the diameter DU of recess 44 is less than diameter DL.

As seen in FIGS. 4 and 5, upon seating of cap 30 fully on can 10, sealing surface 50 engages rim 18 to re-seal can 10 and to grip can 10 with sufficient force to maintain cap 30 in fully sealed engagement with can 10. As best seen in FIG. 5, with cap 30 seated in sealed engagement with can 10, rim 18 is engaged by sealing surface 50 along an annular sealing portion 60 of sealing surface 50. In order to assure an effective seal, as well as establish a grip upon rim 18 that will maintain cap 30 in place in sealing engagement with can 10, sealing portion 60 is located intermediate an upper portion 62 of sealing surface 50 and a lower portion 64 of sealing surface 50.

The renitent characteristics made available at the sealing surface 50, as provided by the combination of elasticity and hardness described above, acting in concert with the material of rim 18, effects a slip-stick advancement of the cap 30 onto the can 10, with a concomitant creation of a sound that becomes discernable as the cap 30 is moved axially into a fully sealed relationship with the rim 18 of can 10. This phenomenon of a “slip-stick” advancement is due to the fact that the static friction of a system is not constant but depends on the duration of static contact between two surfaces. Thus, in the choice of materials and dimensions for member 36 of cap 10, as identified above, a sliding system wherein cap 30 is moved axially over rim 18 provides a static friction between member 36 and rim 18 greater than a kinetic friction, resulting in intermittent sliding, called “stick-slip” and an accompanying sound. Upon the cap 30 reaching an effective seal on rim 18, the static friction will become high enough so that the slip-stick advancement will cease, as will the sound, thus providing the user with an audibly discernable signal indicative of the completion of a fully sealed relationship between the cap 30 and the can 10. This unique feature provides the user with assurance that an effective seal has been created.

The arrangement wherein the sealing portion 60 is placed intermediate the upper portion 62 and the lower portion 64 provides for some clearance between the closed top 32 of cap 30 and the top 14 of can 10, allowing compensation for any slight variations in the diameter of rim 18 from can to can. At the same time, sealing construct 34 provides sufficient surface area at outer perimeter 42 for a fully functional handgrip 46 facilitating grasping of cap 30 during applying and removing cap 30 to and from can 10.

It will be seen that the present invention enables simple re-sealing of any volume of contents remaining in a beverage can to be stored for subsequent use and attains all of the objects and advantages summarized above, namely: Provides a one-piece cap of simple construction for use in establishing an effective seal for re-sealing an open carbonated beverage container; enables increased simplicity and ease in effectively re-sealing a carbonated beverage can for preserving carbonation of the contents of the can; provides a user with an audibly discernable signal indicative of the completion of an effective seal at the top of an otherwise open carbonated beverage can; provides a simplified construction in an effective cap for re-sealing beverage containers, enabling economical manufacture in large numbers of consistent high quality, exceptional durability and ease of use, capable of exemplary performance over an extended service life.

It is to be understood that the above detailed description of preferred embodiments of the invention is provided by way of example only. Various details of design, construction and procedure may be modified without departing from the true spirit and scope of the present invention, as set forth in the appended claims.

The embodiments of the invention in which an exclusive property or privilege is claimed are defined as follows:

1. A cap for re-sealing a container having an axially extending body with a laterally extending top surrounded by a rim having prescribed lateral dimensions, the top including a dispensing opening therein, the cap comprising:
a member having an axial length between an upper end and a lower end, and an outer perimeter along lateral widths greater than the lateral dimensions of the rim;
a recess extending axially within the member, from the lower end toward the upper end of the member, the recess being spaced laterally from the outer perimeter of the member and axially from the upper end of the member; and
an internal engagement surface extending along the recess between the lower end and the upper end of the member, the internal engagement surface having a tapered configuration following a taper angle providing a sealing surface intermediate the upper and lower ends, the sealing surface having interior dimensions complementary to the prescribed lateral dimensions of the rim;
the member including a sealing construct of a material having a combination of elasticity and hardness providing renitent characteristics such that upon engagement of the sealing surface with the rim of the container, relative movement between the cap and the container to effect axial movement between the sealing surface and the rim urging the upper end of the member axially toward the rim will effect a stick-slip advancement of the member onto the container and a concomitant audibly discernable signal indicative of the completion of a sealed relationship between the member and the rim and, consequently, an effective seal between the cap and the container.

2. The cap of claim 1 wherein the taper angle is about 2° to 6°.

3. The cap of claim 1 wherein the taper angle is about 4°.

4. The cap of claim 1 wherein the material has a modulus of elasticity of about 250,000 to 600,000 psi.

5. The cap of claim 1 wherein the material has a hardness of about Shore D70 to Rockwell R150.

6. The cap of claim 1 wherein the material is a synthetic polymeric material selected from the group consisting of acrylic, polycarbonate, and rigid polyurethane.

7. The cap of claim 1 wherein the taper angle is about 2° to 6°, and the material has a modulus of elasticity of about 250,000 to 600,000 psi and a hardness of about Shore D70 to Rockwell R150.

8. The cap of claim 7 wherein the material is a synthetic polymeric material selected from the group consisting of acrylic, polycarbonate, and rigid polyurethane.

9. The cap of claim 1 wherein the container has a cylindrical configuration in which the rim has a circular configuration such that the prescribed dimensions include a given diameter, and the sealing surface has a frusto-conical configuration following the taper angle from a larger diameter adjacent the lower end of the member to a smaller diameter adjacent the upper end of the member, the larger diameter being larger than the given diameter of the rim, and the smaller diameter being smaller than the given diameter of the rim.

10. The cap of claim 9 wherein the taper angle is about 2° to 6°.

11. The cap of claim 9 wherein the taper angle is about 4°.

12. The cap of claim 9 wherein the material has a modulus of elasticity of about 250,000 to 600,000 psi.

13. The cap of claim 9 wherein the material has a hardness of about Shore D70 to Rockwell R150.

14. The cap of claim 9 wherein the material is a synthetic polymeric material selected from the group consisting of acrylic, polycarbonate, and rigid polyurethane.

15. The cap of claim 9 wherein the taper angle is about 2° to 6°, and the material has a modulus of elasticity of about 250,000 to 600,000 psi and a hardness of about Shore D70 to Rockwell R150.

16. The cap of claim 15 wherein the material is a synthetic polymeric material selected from the group consisting of acrylic, polycarbonate, and rigid polyurethane.

17. A method for re-sealing a container having an axially extending body with a top surrounded by a rim having prescribed lateral dimensions, the top including a dispensing opening therein, the method comprising:
providing a cap including a member having an axial length between an upper end and a lower end, and an outer perimeter along lateral widths greater than the lateral dimensions of the rim, a recess extending axially within the member, from the lower end toward the upper end of the member, the recess being spaced laterally from the outer perimeter of the member and axially from the upper end of the member, and an internal engagement surface extending along the recess between the lower end and the upper end of the member, the internal engagement surface having a tapered configuration following a taper angle providing a sealing surface intermediate the upper and lower ends, the sealing surface having interior dimensions complementary to the prescribed lateral dimensions of the rim, the member including a sealing construct of a material having a combination of elasticity and hardness providing renitent characteristics;
engaging the sealing surface with the rim of the container; and
effecting relative movement between the cap and the container to bring about axial movement between the sealing surface and the rim urging the upper end of the member axially toward the rim in a stick-slip advancement of the member onto the container until an audible signal indicates completion of a sealed relationship between the member and the rim and, consequently, an effective seal between the cap and the container.
